(19) United States
(12) Patent Application Publication
(10) Pub. No.: US 2012/0043838 A1
(43) Pub. Date: Feb. 23, 2012

(54) ELECTRICAL CONNECTOR FOR A MOTOR

(75) Inventors: STEVEN LEE FLICKINGER, HUMMELSTOWN, PA (US); WILLIAM G. LENKER, MARYSVILLE, PA (US); KASTHURI SANKAR DAMODHARAN, HARRISBURG, PA (US)

(73) Assignee: TYCO ELECTRONICS CORPORATION, BERWYN, PA (US)

(21) Appl. No.: 12/858,992

(22) Filed: Aug. 18, 2010

(51) Int. Cl. H02K 11/00

(52) U.S. Cl. 310/71

(57) ABSTRACT

An electrical contact is provided. The contact includes a positioning body configured to position the contact in a connector housing, wherein the connector housing is mounted to a housing of the motor. A wire end extends from the positioning body and is configured to be positioned within the housing of the motor. The wire end is configured to connect to a wire of the motor. A termination end extends from the positioning body opposite the wire end. The termination end is configured to be positioned outside the housing of the motor. The termination end is electrically joined to the wire end. A pair of termination prongs is formed at the termination end of the contact. The pair of termination prongs is configured to terminate the wire of the motor. The pair of termination prongs is configured to connect to a power cable of an electrically powered device.

### BACKGROUND OF THE INVENTION

The subject matter described herein relates generally to motors and, more particularly to an electrical connector for a motor.

Motors are frequently used in electrically powered devices, for example, appliances and the like. The motor receives power from the electrically powered device. In particular, magnetic wires provided in the motor are connected to a power cable of the electrically powered device to provide power to the motor. The magnetic wires are typically terminated within the motor and joined to a lead wire that extends through a housing of the motor. The lead wire is then joined to the power cable of the electrically powered device. The power cable delivers an electrical current to the motor to drive the motor, thereby operating the electrically powered device.

However, conventional connectors used in motors are not without disadvantages. As set forth above, the magnetic wires of the motor are typically terminated to the lead wire within the motor. Terminating the magnetic wires within the motor may increase production time and cost. In particular, the magnetic wires must be coupled to an additional component, for example, the lead wire that joins the magnetic wire and the power cable. Moreover, if the motor malfunctions, the motor may have to be opened to access the termination end of the magnetic wires. The lead wire may also be required to be replaced, thereby adding costs to the maintenance and repair of the motor. Additionally, the lead wires generally include a single termination per magnetic wire. As a result, multiple magnetic wires must be terminated to the lead wire to provide power to the motor. Having multiple magnetic wires increases the chance of the motor malfunctioning and/or becoming damaged.

A need remains for an electrical connector that terminates the magnetic wires of a motor outside the motor housing.

### SUMMARY OF THE INVENTION

In one embodiment, an electrical connector is provided. The electrical connector includes a connector housing having a wire end and a termination end. An opening extends between the wire end and the termination end. The housing is configured to mount to a housing of a motor such that the wire end of the connector housing is positioned within a motor housing and the termination end of the connector housing is positioned outside of the motor housing. The termination end of the connector is configured to receive a power cable from an electrically powered device. A contact is provided having a wire end and a termination end. The contact is positioned and oriented within the opening of the connector housing so that the wire end of the contact is located within the wire end of the connector housing and the termination end of the contact is located within the termination end of the connector housing. The wire end of the contact is configured to connect to a wire of the motor. A pair of termination prongs is formed at the termination end of the contact. The pair of termination prongs is configured to terminate the wire of the motor. The pair of termination prongs is configured to connect to the power cable of the electrically powered device.

In another embodiment, an electrical contact is provided. The contact includes a positioning body configured to position the contact in a connector housing, wherein the connector housing is mounted to a housing of the motor. A wire end extends from the positioning body and is configured to be positioned within the housing of the motor. The wire end is configured to connect to a wire of the motor. A termination end extends from the positioning body opposite the wire end. The termination end is configured to be positioned outside the housing of the motor. The termination end is electrically joined to the wire end. A pair of termination prongs is formed at the termination end of the contact. The pair of termination prongs is configured to terminate the wire of the motor. The pair of termination prongs is configured to connect to a power cable of an electrically powered device.

### BRIEF DESCRIPTION OF THE DRAWINGS

FIG. 1 is a schematic of a motor formed in accordance with an embodiment and coupled to an electrically powered device.

FIG. 2 is a front perspective view of an electrical connector formed in accordance with an embodiment that may be used with the motor shown in FIG. 1.

FIG. 3 is front perspective view of the electrical connector shown in FIG. 2 having the cover in a closed position.

FIG. 4 is a back perspective view of the electrical connector shown in FIG. 2.

FIG. 5 illustrates an exploded view of the area 5 shown in FIG. 4.

FIG. 6 is a top perspective view of a contact formed in accordance with an embodiment.

FIG. 7 is a view of a blank formed in accordance with an embodiment and configured to form the contact shown in FIG. 6.

### DETAILED DESCRIPTION OF THE DRAWINGS

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

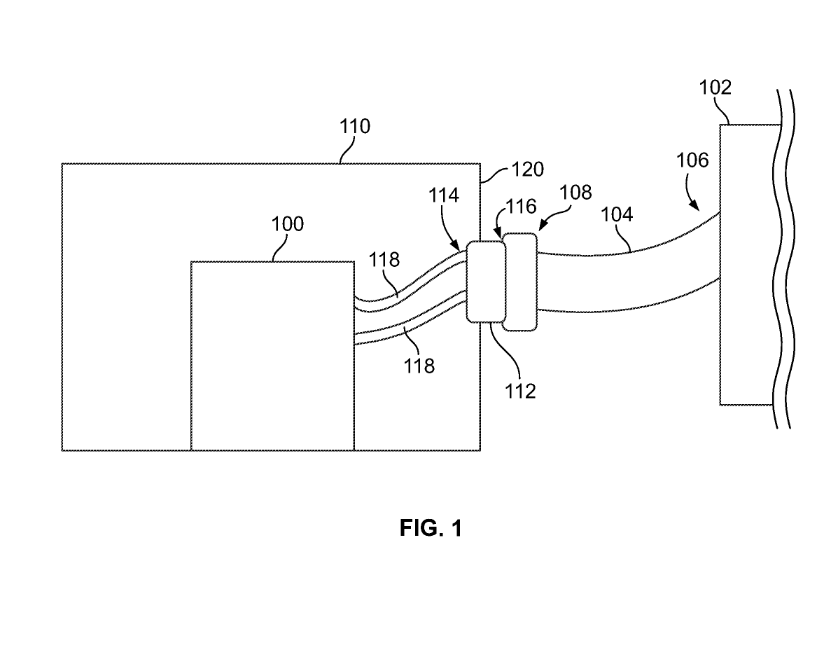

FIG. 1 illustrates a motor 100 formed in accordance with an embodiment and coupled to an electrically powered device 102. The electrically powered device may be an appliance, for example, a dishwasher or the like. The motor 100 is an electrical motor that is configured to operate a mechanical portion of the electrically powered device 102. The motor 100 is illustrated as being separated from the electrically powered device 102. Alternatively, the motor 100 is housed within the electrically powered device 102. The electrically powered device 102 includes a power cable 104 extending therefrom. The power cable 104 includes a device end 106 and a connector end 108. The device end 106 connects to the electrically powered device 102.

The motor 100 is surrounded by a housing 110. The housing 110 is configured to protect the motor 100 and those in contact with the motor 100. The housing 110 has an electrical connector 112 positioned therein. The electrical connector 112 includes a wire end 114 and a termination end 116. The termination end 116 is configured to engage the connector end 108 of the power cable 104. The wire end 114 is configured to engage wires 118 that extend from the motor 100. The wires 118 terminate at the electrical connector 112. The electrical connector 112 is joined to a wall 120 of the housing 110 to avoid having to terminate the wires 118 within the housing 110 and extending lead wires through the housing 110. The power cable 104 directs power from the electrically powered device 102 to the wires 118 of the motor 100. The wires 118 direct the power to the motor 100 to drive the motor 100. In turn, the motor 100 operates a mechanical device of the electrically powered device 102.

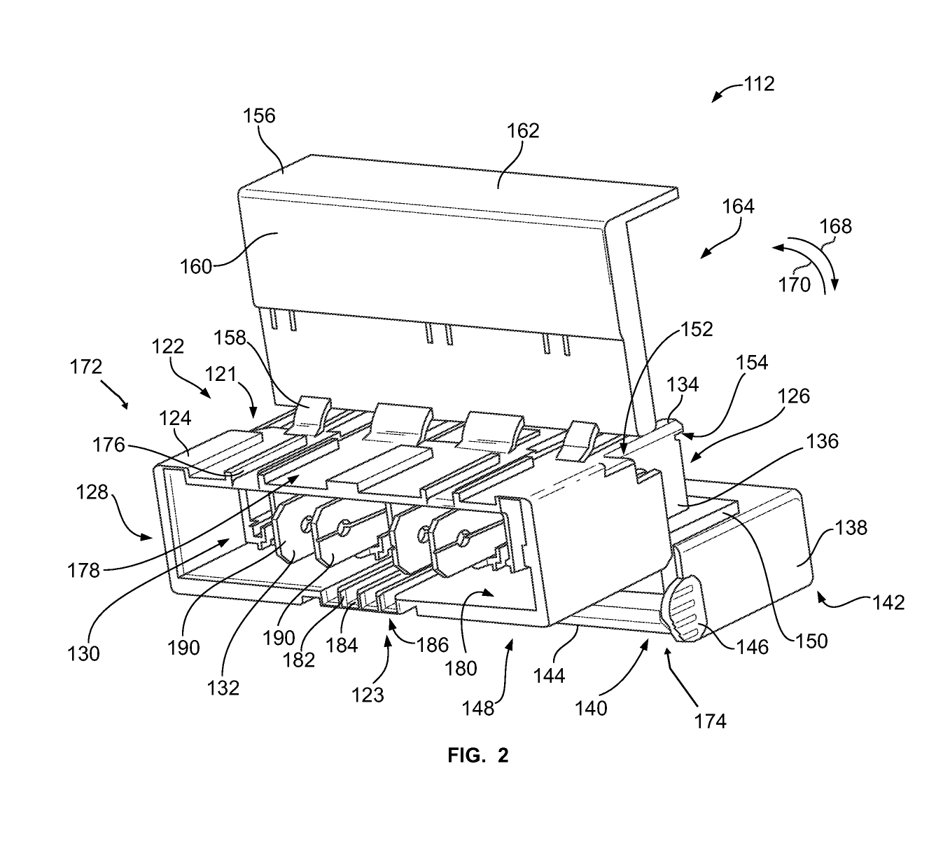

FIG. 2 illustrates the electrical connector 112. The electrical connector 112 includes a housing 122 having a body 124. The body 124 includes a top 121 and a bottom 123. The body 124 includes a wire end 126 and termination end 128. The wire end 126 extends from the termination end 128. The wire end 126 and the termination end 128 may be integrally formed. In another embodiment, the wire end 126 and the termination end 128 may be formed as separate pieces that are mechanically joined. An opening 130 extends through the body 124 between the wire end 126 and the termination end 128. The opening 130 includes contacts 132 extending therethrough. The contacts 132 are configured to electrically couple the wires 118 (shown in FIG. 1) and the connector end 108 (shown in FIG. 1) of the cable 104 (shown in FIG. 1). The wires 118 are configured to be received in the wire end 126 of the connector 112. The connector end 108 of the cable 104 is configured to be received in the termination end 128 of the connector 112.

The wire end 126 includes a top 134 and a bottom 136. A motor engagement flange 138 extends from the bottom 136 of the termination end 128. The motor engagement flange 138 may be formed integrally with the wire end 126. Optionally, the motor engagement flange 138 and the wire end 126 may be formed as separate pieces that are mechanically joined. The motor engagement flange 138 is configured to engage the wall 120 (shown in FIG. 1) of the motor housing 110 (shown in FIG. 1) to align the connector 112 with respect to the wall 120. The motor engagement flange 138 may also retain the connector 112 within the wall 120 of the motor housing 110. The motor engagement flange 138 includes a front end 140 and a back end 142. The front end 140 includes an alignment rail 144 that extends along the front end 140. The alignment rail 144 positions the connector 112 with respect to the wall 120 of the motor housing 110. The front end 140 includes a tab 146 that engages the wall 120 to retain the connector 112 within the motor housing 110. In an alternative embodiment, the front end 140 of the motor engagement flange 138 may includes notches, grooves, protrusions, or the like to align and retain the connector 112 with respect to the motor housing 110. The wire end 126 of the connector 112 is configured to position within the motor housing 110. The termination end 128 of the connector 112 is configured to position outside of the motor housing 110.

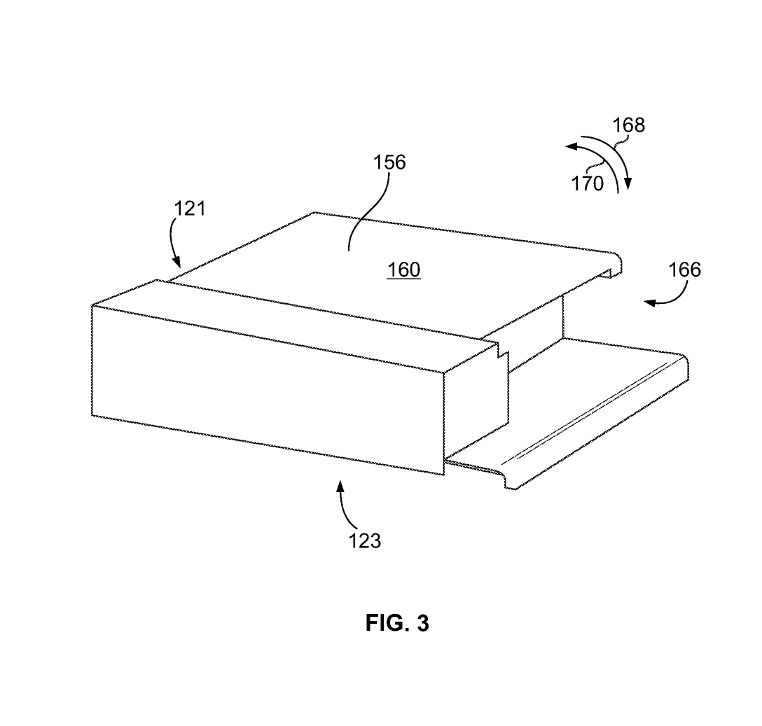

The termination end 128 includes a front 148 and a back 150. The wire end 126 includes a front 152 and a back 154. The back 150 of the termination end 128 is joined to the front 152 of the wire end 126. The back 150 of the termination end 128 includes a cover 156 coupled thereto. The cover 156 is joined to the back 150 of the termination end 128 with hinges 158. The cover 156 includes a top 160 and a shield 162. The shield 162 extends at an angle from the top 160. The cover 156 is configured to rotate about the hinges 158 in the direction of arrows 168 and 170 between an open position 164 (illustrated in FIG. 2) and a closed position 166 (illustrated in FIG. 3). In the open position 164, the cover 156 extends upward from the top 121 of the connector 112. In the open position 164, the wires 118 are can be inserted into the wire end 126 of the connector 112.

Referring to FIG. 3, in the closed position 166, the cover 156 is rotated downward in the direction of arrow 168. In the closed position 166, the top 160 of the cover 156 extends along the top 121 of the connector 112. The shield 162 extends toward the bottom 123 of the connector 112. The shield 162 extends along the wire end 126 of the connector 112. The cover 156 is configured to shield and protect the wires 118 (shown in FIG. 1) extending from the wire end 126 of the connector 112. The cover 156 is moveable in the direction 170 into the open position 164 (illustrated in FIG. 2).

Referring back to FIG. 2, the termination end 128 includes a top 172 and a bottom 174. The top 172 includes protrusions 176. The protrusions 176 extend from the front 148 of the termination end 128 to the back 150 of the termination end 128. Grooves 178 are formed between adjacent protrusions 176. The grooves 178 and the protrusions 176 are configured to receive corresponding grooves and protrusions formed on the connector end 108 of the cable 104. The grooves 178 and protrusions 176 are configured to align the connector end 108 of the cable 104 on the termination end 128 of the connector 112. The grooves 178 and protrusions 176 retain the connector end 108 of the cable 104 on the termination end 128 of the connector 112. Optionally, the termination end 128 of the connector 112 may include notches, latches, or the like that are configured to engage corresponding features on the connector end 108′ of the cable 104.

The opening 130 defines an inner surface 180 of the termination end 128. The inner surface 180 includes protrusions 182 and grooves 184. The grooves 184 are formed between adjacent protrusions 182. The grooves 184 and protrusions 182 are illustrated at a center 186 of the termination end 128. Alternatively, the grooves 184 and protrusions 182 may be located at any point along the inner surface 180 of the termination end 128. The grooves 184 and protrusions 182 engage corresponding grooves and protrusions formed on the connector end 108 of the cable 104. Optionally, the termination end 128 of the connector 112 may include notches, latches, or the like that are configured to engage corresponding features on the connector end 108 of the cable 104.

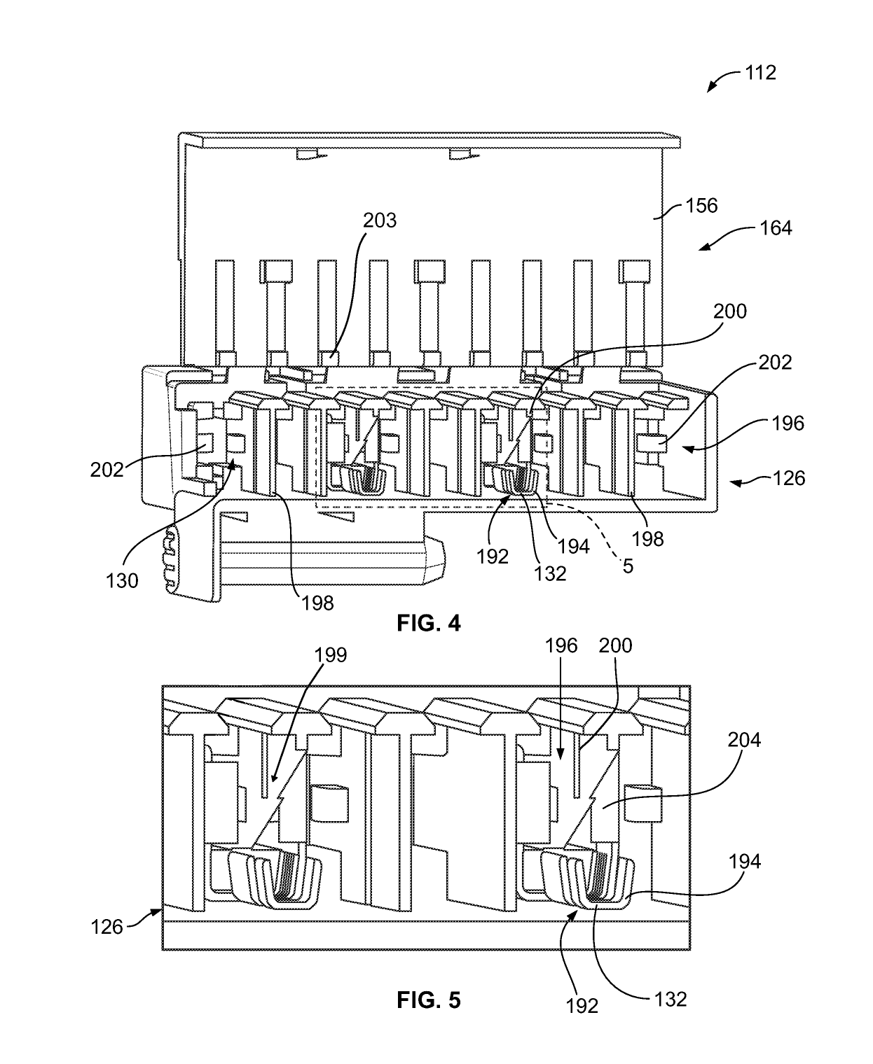

The contacts 132 extend through the opening 130 of the termination end 128. The contacts 132 include a termination end 190 and a wire end 192 (shown in FIG. 4). The termination ends 190 of each contact 132 extend through the termination end 128 of the connector 112. Each contact 132 includes two termination ends 190 that are configured to engage the connector end 108 of the cable 104. The two termination ends 190 extend from a single wire end 192 to provide dual termination for a single wire 118. The contacts 132 eliminate the need for lead wires extending from the motor 100.

FIG. 4 illustrates a back perspective view of the connector 112.

FIG. 4 illustrates the connector 112 having the cover 156 in the open position 164. When the cover 156 is in the open position 164, the wire end 126 of the connector 112 is accessible. The wire end 192 of each contact 132 extends through the opening 130 in the wire end 126 of the connector 112. Each contact 132 includes a single wire end 192 coupled to two termination ends 190 (shown in FIG. 3). The wire end 192 includes a crimp 194. The crimp 194 is configured to crimp to one of the wires 118 (shown in FIG. 1) extending from the motor 100 (shown in FIG. 1). Alternatively, the wire end 192 may include a wire that is twisted to the wire 118. In another embodiment, the wire end 192 of the contact 132 may otherwise electrically couple to the wire 118.

The opening 130 of the wire end 126 of the connector 112 includes ports 196 spaced along the wire end 126. The ports 196 are defined between walls 198. The ports 196 are configured to receive a contact 132 therein. Each port 196 that is configured to receive a contact 132 includes a half-wall 200. The half-wall 200 enables a contact 132 having dual termination ends 190 to be inserted through the port 196. Each termination end 190 is configured to be received on one side of the half-wall 200. The crimp 194 is positioned below the half-wall 200. The ports 196 include tabs 202 extending from the walls 198. The tabs 202 are configured to engage the contact 132 to retain the contact 132 within the port 196. Alternatively, the ports 196 may include grooves, notches, latches, or the like to retain the contacts 132 therein.

FIG. 5 illustrates an exploded view of the area 5 shown in FIG. 4. The contacts 132 are inserted into ports 196. The contacts 132 include shoulders 204 that are positioned proximate to the crimp 194. The shoulders 204 are positioned above the crimp 194. A shoulder 204 is provided on each side of the crimp 194. The shoulders 204 may extend from the termination ends 190 (shown in FIG. 2) of the contact 132. The shoulders 204 provide a surface for inserting the contact 132 into the port 196. The contact 132 is inserted into the port 196 from the wire end 126 of the connector 112. The contact 132 is positioned between the walls 198. The contact 132 is positioned within the port 196 so that the termination ends 190 of the contact 132 are positioned on opposite sides of the half-wall 200. The port 196 includes an alignment slot 199 to align the contact 132 therein.

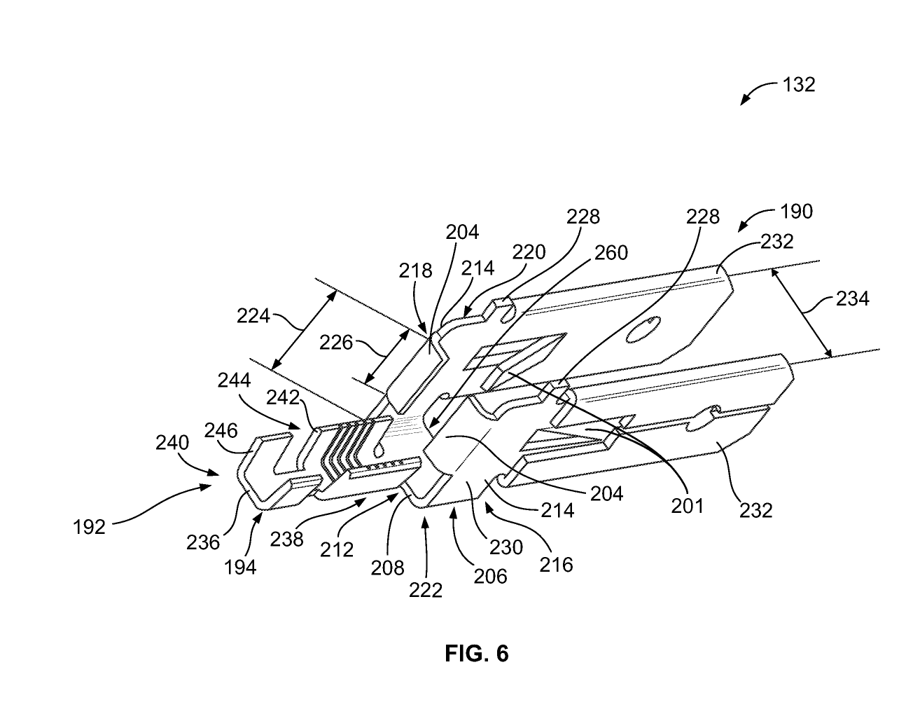

Force is applied to the shoulders 204 of the contact 132 so that the contact slides into the port 196. The shoulders 204 provide a surface to receive the force without placing force on the crimp 194 of the contact 132. When the contacts are pushed into the port 196, a retention clip 201 (shown in FIG. 6) slides into the port 196 and stops. The alignment tab 197 hits the top of the housing 122 and the retention clips 201 are positioned within the housing 122. Once the retention clips 201 are positioned, the retention clips 201 are bent back so that the contacts 132 cannot pushed back. A wedge like feature 203 (shown in FIG. 4) at the bottom of the cover 156 prevents the contacts 132 from dislodging. The wire 118 is connected to the crimp 194 prior to the contact 132 being inserted into the port 196. Force applied to the crimp 194 may dislodge the wire 118. The shoulders 204 prevent the wire 118 from becoming dislodged from the contact 132 as the contact 132 is inserted into the port 196. When the contact 132 is positioned within the connector 112, the termination ends 190 of the contact extend through the termination end 128 of the connector 112. The wire end 192 of the contact 132 extends through the wire end 126 of the connector 112. The crimp 194 is positioned below the half-wall 200. The contact 132 is retained in position by the tabs 202. The contact 132 is retained so that the termination ends 190 of the contact 132 can be engaged by the connector end 108 (shown in FIG. 1) of the cable 104 (shown in FIG. 1).

After the contacts 132 are inserted into the ports 196, the cover 156 is moved into the closed position 164 to protect the wires 118 extending from the wire end 126 of the connector 112. The shield 162 of the cover 156 protects the wires 118 from substances such as dust, water, and the like.

FIG. 6 illustrates a contact 132. The contact 132 includes the termination ends 190 and the wire end 192. A positioning body 206 extends between the termination ends 190 and the wire end 192. The positioning body 206 is configured to align the contact 132 with a port 196. The positioning body 206 includes a base 208 having a front 210 and a back 212. The base 208 has a planar configuration. Optionally, the base 208 may have a non-planar configuration. Opposite sides 214 extend from the base 208. The sides 214 extend between the front 210 and back 212 of the base 208. Optionally, the sides 214 may extend any distance along an intermediate location between the front 210 and the back 212 of the base 208. The sides 214 extend orthogonally from the base 208. In another embodiment, the sides 214 may extend at any angle from the base 208. The sides 214 may extend at the same angle with respect to the base 208. Optionally, the sides 214 may extend at different angles with respect to the base 208.

The sides 214 include a front 216 and a back 218. The sides 214 include a top 220 and bottom 222. The bottom 222 is joined to the base 208. Each side 214 has a height 224 defined between the top 220 and the bottom 222. The shoulders 204 extend from the back 218 of the sides 214. The illustrated embodiment shows a shoulder 204 extending from each side 214. Optionally, the contact 132 may include one shoulder 204 extending from one side 214. Each shoulder 204 extends inward toward the opposite side 214. In another embodiment, the shoulders 204 may extend outward away from the opposite side 214. In one embodiment, one shoulder 204 may extend inward and the other shoulder 204 may extend outward. The shoulders 204 extend a length 226 along the sides 214. The length 226 is less than the height 224 of the sides 214. Optionally, the shoulders 204 may extend the entire height 224 of the sides 214. In the illustrated embodiment, the shoulders 204 extend the same length 226. Alternatively, the shoulders 204 may extend different lengths 226. The shoulders 204 are positioned proximate to the top 220 of the sides 214. In another embodiment, the shoulders 204 may be positioned at any intermediate location between the top 220 and the bottom 222 of the sides 214.

An alignment tab 228 extends from each side 214. In another embodiment, the contact 132 includes one alignment tab 228 extending from one of the sides 214. Optionally, either side 214 may include multiple alignment tabs 228. The alignment tabs 228 extend from the top 220 of each side 214. Optionally, the alignment tabs 228 may extend from the bottom 222 of each side 214 and/or from an outer surface 230 of each side 214. The alignment tabs 228 extend proximate to the termination ends 190 of the contact 132. The alignment tabs 228 may extend proximate to the wire end 192 of the contact 132. Alternatively, an alignment tab 228 may be positioned proximate to both the termination end 190 and the wire end 192. In another embodiment, the alignment tab 228 may be positioned at any intermediate location along the side 214 between the termination ends 190 and the wire end 192. Once the alignment tabs 228 hit the top of the housing 122, the alignment tabs 228 prevent the contact 132 from moving forward. The wedge like feature 203 and the retention clips 201 prevent the contact 132 from moving backward and dislodging

A termination end 190 extends from the front 216 of each side 214. In an exemplary embodiment, the termination ends 190 are formed as blades 232. The blades 232 are configured to be received in slots formed in the connector end 108 (shown in FIG. 1) of the cable 104 (shown in FIG. 1). Alternatively, the termination ends 190 may be formed as pins, posts, or the like. In one embodiment, the termination ends 190 are formed as any suitable electrical connector that provides dual termination. The blades 232 extend in parallel from the front 216 of each side 214. The blades 232 are spaced a distance 234. The distance 234 is selected based on a configuration of the connector end 108 of the cable 104. The blades 232 are oriented in parallel with the sides 214 of the positioning body 206. In an alternative embodiment, the blades 232 may be oriented at an angle with respect to the sides 214. The blades 232 may be oriented at the same angle with respect to the sides 214. Optionally, each blade 232 may be oriented at a different angle with respect to the sides 214.

The wire end 192 extends from the base 208 of the positioning body 206. Optionally, the wire end 192 may extend from one of or both of the sides 214. The wire end 192 is centered between the sides 214. Optionally, the wire end 192 may be positioned proximate to one of the sides 214. The wire end 192 includes a base 236. The base 236 extends from the base 208 of the positioning body 206. The base 236 includes a front 238 and a back 240. The front 238 of the base 236 is joined to the base 208 of the positioning body 206. A first pair of opposite sides 242 extends from the base 236 proximate to the front 238 of the base 236. The sides 242 and the base 236 form a crimp 244. The crimp 244 is configured to receive a wire 118 (shown in FIG. 1) of the motor 100 (shown in FIG. 1). The wire 118 is positioned on the base 236. The sides 242 are configured to fold downward toward the base 236 to crimp the wire between the sides 242 and the base 236.

A second pair of opposite sides 246 extends from the base 236 proximate to the back 240 of the base 236. The sides 246 form the crimp 194. The crimp 194 receives the wire 118 therein. The sides 246 are bent toward the base 236 to crimp the wire 118 between the sides 246 and the base 236. The crimp 194 and the crimp 244 retain the wire 118 within the contact 132. The crimps 194 and 244 form an electrical connection between the wire 118 extending from the motor 100 and the contacts 132.

The connector 112 provides an electrical connection between the wires 118 of the motor 100 and the cable 104 of the electrically powered device 102. The connector 112 enables dual termination of a single wire 118 thereby reducing a number of wires 118 that are required to extend from the motor 100. The connector 112 also enables the wires 118 to be terminated at the housing 110 of the motor 100. The wires 118 are not required to be terminated to lead wires that extend from the housing 110. Rather, the wires 118 are terminated at the housing, thereby eliminating the need for lead wires. Terminating the wires 118 at the motor housing 110 reduces time and costs associated with assembly and maintenance of the motor 100.

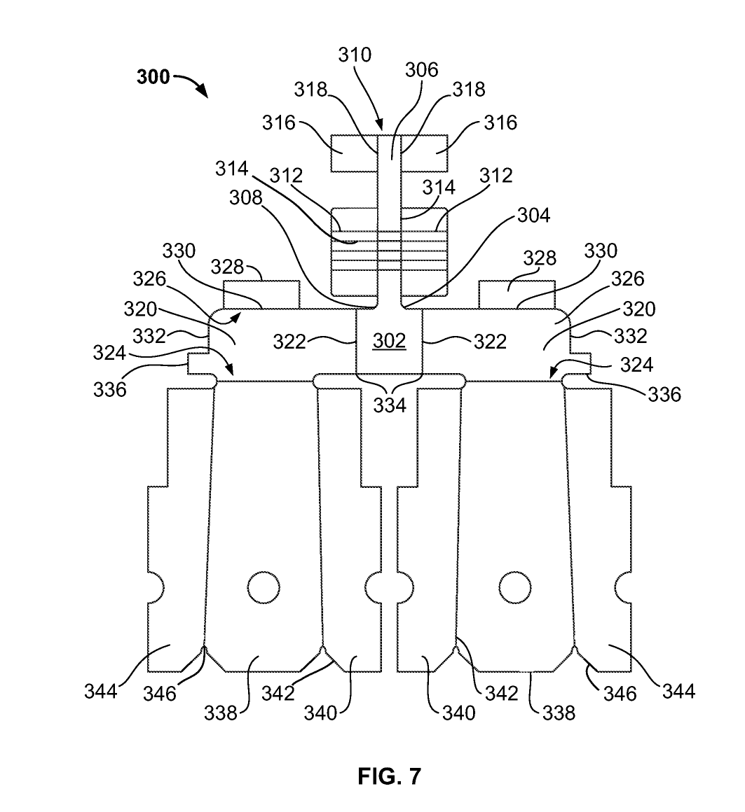

FIG. 7 illustrates a blank 300 formed in accordance with an embodiment and that may be used to form the contact 132 (shown in FIG. 6). The blank 300 is stamped and formed to form the contact 132. The blank 300 includes a center panel 302. The center panel 302 includes a back end 304. A crimp panel 306 extends from the back end 304 of the center panel 302. The crimp panel 306 includes a front end 308 coupled to the back end 304 of the center panel 302. The crimp panel 306 includes a back end 310 positioned opposite the front end 308. A pair of sides 312 extend along opposite fold lines 314 proximate to the front end 308 of the crimp panel 306. Another pair of sides 316 extend along opposite fold lines 318 proximate to the back end 310 of the crimp panel 306.

The sides 312 are configured to fold along the fold lines 314. The sides 312 are folded substantially orthogonally with respect to the crimp panel 306. The sides 312 and the crimp panel 306 form the crimp 194 of the contact 132. The sides 316 are configured to fold along the fold lines 318. The sides 316 are folded substantially orthogonally with respect to the crimp panel 306. The side 316 and the crimp panel 306 form the crimp 244 of the contact 132.

Side panels 320 extend from the center panel 302 along fold lines 322. The side panels 320 include a front end 324 and a back end 326. Tabs 328 extend along the back end 326. The tabs 328 extend along a fold line 330. The side panels 320 also include a top 332 and a bottom 334. The bottom 334 is joined to the center panel 302 along the fold line 322. A tab 336 extends from the top 332 of each side panel 320.

The side panels 320 are folded along the fold lines 322. The side panels 320 are folded substantially orthogonally with respect to the center panel 302. The side panels 320 and the center panel 302 form the positioning body 206 of the contact 132. The tabs 336 extend from the top 332 of each side panel 320 to form the alignment tabs 228 of the contact 132. The tabs 328 are folded along the fold line 330 to form the shoulders 204 of the contact 132. The tabs 328 are folded substantially orthogonally with respect to the side panels 320.

A blade panel 338 extends from the front 324 of each side panel 320. The blade panels 338 include an inner side panel 340 extending along a fold line 342. The blade panels 338 include an outer side panel 344 extending along a fold line 346. The inner side panels 340 are folded along the fold line 342. The inner side panels 340 are positioned to abut the blade panel 338. The outer side panels 344 are folded about the fold line 346. The outer side panels 344 are positioned to abut the blade panel 338. The blade panel 338 and the inner and outer side panels 340 and 344 form the blades 232 of the contact 132.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An electrical connector, said electrical connector comprising:
a connector housing having a wire end and a termination end, an opening extending between the wire end and the termination end, the housing configured to mount to a housing of a motor so that the wire end of the connector housing is positioned within a motor housing and the termination end of the connector housing is positioned outside of the motor housing, the termination end of the connector configured to receive a power cable from an electrically powered device;
a contact having a wire end and a termination end, the contact positioned and oriented within the opening of the connector housing such that the wire end of the contact is located within the wire end of the connector housing and the termination end of the contact is located within the termination end of the connector housing, the wire end of the contact configured to connect to a wire of the motor;
a pair of termination prongs formed at the termination end of the contact, the pair of termination prongs configured to terminate the wire of the motor, the pair of termination prongs configured to connect the power cable of the electrically powered device.

2. The electrical connector of claim 1, wherein the wire end of the contact is formed as a crimp configured to secure to the wire of the motor.

3. The electrical connector of claim 1, wherein the termination prongs are formed as blades configured to be received in slots of the power cable of the electrically powered device.

4. The electrical connector of claim 1, wherein the contact includes a positioning body between the wire end and the termination end, the positioning body configured to align and position the contact within the connector housing.

5. The electrical connector of claim 1, wherein the contact includes a positioning body between the wire end and the termination end, the positioning body having an alignment tab, the connector housing including an alignment slot, the alignment tab received in the alignment slot to align the contact within the opening of the connector housing.

6. The electrical connector of claim 1, wherein the contact includes a positioning body between the wire end and the termination end, the positioning body including a shoulder that is configured to receive force when the contact is positioned within the opening in the connector housing.

7. The electrical connector of claim 1, wherein the contact includes a positioning body between the wire end and the termination end, the positioning body having a base and a pair of opposite sides extending from the base, each of the pair of termination prongs extending from one of the sides of the positioning body.

8. The electrical connector of claim 1, wherein the contact includes a positioning body between the wire end and the termination end, the positioning body having a base and a pair of opposite sides extending from the base, the wire end of the contact extending from the base of the positioning body.

9. The electrical connector of claim 1, wherein the connector housing includes multiple openings to receive multiple contacts.

10. The electrical connector of claim 1, wherein the connector housing includes a cover configured to protect the wire of the motor.

11. The electrical connector of claim 1, wherein the contact is stamped and formed.

12. An electrical contact, the contact comprising a positioning body configured to position the contact in a connector housing, wherein the connector housing is mounted to a housing of a motor;
a wire end extending from the positioning body and configured to be located within the housing of the motor, the wire end configured to connect to a wire of the motor;
a termination end extending from the positioning body opposite the wire end, the termination end configured to be located outside the housing of the motor, the termination end electrically joined to the wire end; and
a pair of termination prongs formed at the termination end of the contact, the pair of termination prongs configured to terminate the wire of the motor, the pair of termination prongs configured to connect to a power cable of an electrically powered device.

13. The electrical contact of claim 12, wherein the wire end is formed as a crimp configured to secure to the wire of the motor.

14. The electrical contact of claim 12, wherein the termination prongs are formed as blades configured to be received in slots of the power cable of the electrically powered device.

15. The electrical contact of claim 12, wherein the positioning body includes an alignment tab configured to be received in an alignment slot of the connector housing to align the contact within the connector housing.

16. The electrical contact of claim 12, wherein the positioning body includes a shoulder that is configured to receive force when the contact is positioned within the connector housing.

17. The electrical contact of claim 12, wherein the positioning body has a base and a pair of opposite sides extending from the base, each of the pair of termination prongs extending from one of the sides of the positioning body.

18. The electrical contact of claim 12, wherein the positioning body has a base and a pair of opposite sides extending from the base, the wire end of the contact extending from the base of the positioning body.

19. The electrical contact of claim 12, wherein the termination prongs extend from the positioning body in parallel to one another.

20. The electrical contact of claim 12, wherein the electrical contact is stamped and formed.
